(19) United States
(12) Patent Application Publication
(10) Pub. No.: US 2017/0241550 A1
(43) Pub. Date: Aug. 24, 2017

(54) SEAL FOR FUEL INJECTOR SYSTEM

(71) Applicant: Caterpillar Inc., Peoria, IL (US)

(72) Inventors: Christian Sabotta, Washington, IL (US); Christopher Woods, East Peoria, IL (US)

(73) Assignee: Caterpillar Inc., Peoria, IL (US)

(21) Appl. No.: 15/046,484

(22) Filed: Feb. 18, 2016

(51) Int. Cl. F16K 1/46; F02M 59/44; F02M 63/00

(52) U.S. Cl. CPC F16K 1/46; F02M 63/0028; F02M 59/442; F02M 2200/16

(57) ABSTRACT

A valve system includes a guide member having a passage, a seal member positioned relative to the passage, and a valve stem disposed within the guide member passage to move axially relative to the guide member and the seal member. The seal member has an inner circumferential surface defining a bore, an outer circumferential surface, and an intermediate seal portion therebetween. The intermediate seal portion includes a first axial end surface and a second axial end surface. The seal member further includes a ramp on at least one of the first axial end surface and the second axial end surface. The ramp is descending from the inner circumferential surface to one of the intermediate seal portion or the outer circumferential surface.

### TECHNICAL FIELD

The present disclosure relates generally to the field of fuel injectors. In particular, the present disclosure relates to a seal member for a fuel injector.

### BACKGROUND

Modern fuel injectors are actuated mechanically, hydraulically, electrically, electronically or by a combination of these mechanisms. These mechanisms are used to move a valve that blocks flow of fuel out of the injectors and into the combustion chamber. Some of these mechanisms use hydraulic oil for actuating parts of the fuel injectors. Thus, a possibility of mixing of hydraulic oil and fuel exists and threatens smooth operation of engines using these injectors.

The possibility of mixing of hydraulic oil and fuel inside injectors may be reduced or eliminated by using a seal member. These seal members, when exposed to the hydraulic oil, may be susceptible to abrasion because of the soot suspended in the hydraulic oil. The problem of seal members being abraded may further be escalated by their typical geometry.

U.S. Pat. No. 6,659,371 discloses a seal having an upper and a lower seal, for preventing the intrusion of liquid fuel into the working moving parts of the fuel injector. The document discloses a seal having an upper cap and a lower cap wherein both the upper and lower cap have substantially radially extending flares.

### SUMMARY OF THE INVENTION

The present disclosure provides for a valve system. The valve system includes a guide member having a passage, a generally annular seal member positioned relative to the passage, and a valve stem disposed within the guide member passage to move axially relative to the guide member and the seal member. The seal member has an inner circumferential surface defining a bore, an outer circumferential surface, and an intermediate seal portion therebetween. The intermediate seal portion includes a first axial end surface and a second axial end surface. The seal member further includes a ramp on at least one of the first axial end surface and the second axial end surface. The ramp is descending from the inner circumferential surface to one of the intermediate seal portion or the outer circumferential surface.

The present disclosure further provides for a fuel injector system. The fuel injector system includes an injector body and a valve system disposed within the injector body. The valve system includes a guide member having a passage, a generally annular seal member positioned relative to the passage, and a valve stem disposed within the guide member passage to move axially relative to the guide member and the seal member. The seal member has an inner circumferential surface defining a bore, an outer circumferential surface, and an intermediate seal portion therebetween. The intermediate seal portion includes a first axial end surface and a second axial end surface. The seal member further includes a ramp on at least one of the first axial end surface and the second axial end surface. The ramp is descending from the inner circumferential surface to one of the intermediate seal portion or the outer circumferential surface.

In yet another aspect, a seal member of generally annular shape is disclosed. The seal member includes an inner circumferential surface defining a bore, an outer circumferential surface, and an intermediate seal portion therebetween. The intermediate seal portion includes a first axial end surface and a second axial end surface. The seal member further includes a ramp on at least one of the first axial end surface and the second axial end surface. The ramp is descending from the inner circumferential surface to one of the intermediate seal portion or the outer circumferential surface.

### BRIEF DESCRIPTION OF THE DRAWINGS

FIG. 1 illustrates a fuel injector system in accordance with an embodiment.

FIG. 2 illustrates an enlarged view of a valve system of the fuel injector system in accordance with an embodiment.

FIG. 3 illustrates an enlarged view of the valve system of the fuel injector system in accordance with an embodiment.

FIG. 4 illustrates an isometric view of the seal member in accordance with an embodiment.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

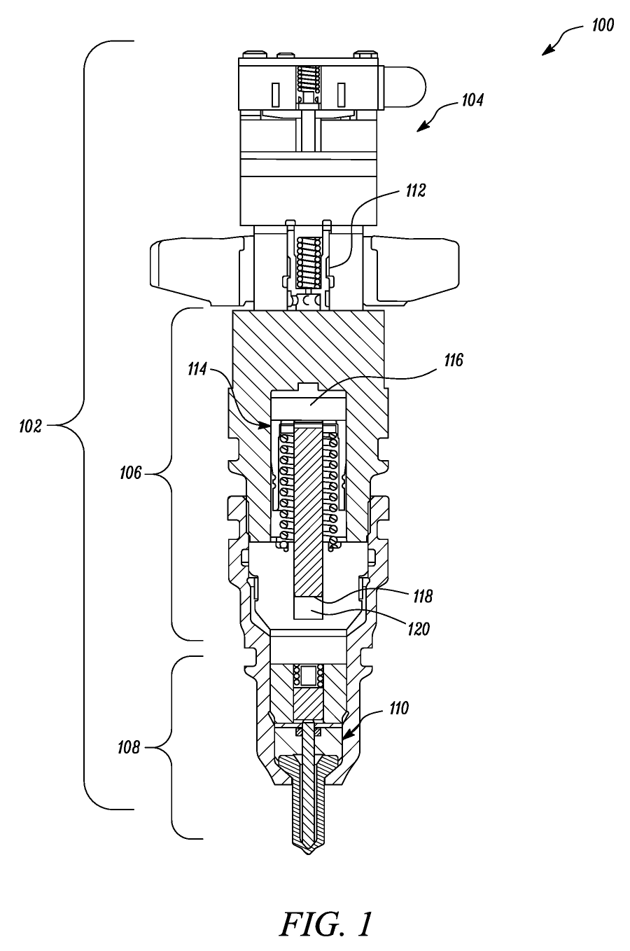

FIG. 1 illustrates an exemplary fuel injector system 100. The fuel injector system 100 may be a mechanically, hydraulically or electronically actuated system. The fuel injector system 100 may be used in an engine (not shown) operating on a two stroke cycle, four stroke cycle or on multiple cycles. It is also contemplated that the fuel injector system 100 may be used for petrol, diesel, gas, methanol, biodiesel or any other suitable fuel. In an embodiment, the fuel injector system 100 is a unit injector system. In an embodiment, the unit injector system is a hydraulically-actuated electronically-controlled unit injector (hereinafter HEUI) system. The fuel injector system 100 may include an injector body 102. The injector body 102 may include a solenoid portion 104, a body portion 106, a nozzle portion 108 and a valve system 110.

As shown in FIG. 1, the solenoid portion 104 may include a solenoid valve 112. The solenoid valve 112 may be a directly operated, pilot operated or semi-directly operated valve. In an embodiment, the solenoid valve 112 is a solenoid operated spool valve. The solenoid portion 104 may be coupled to the body portion 106 of the injector body 102. The body portion 106 may include an intensifier assembly 114. The intensifier assembly 114 may include an intensifier piston 116 coupled to an intensifier plunger 118, and an intensifier chamber 120 in which the intensifier plunger 118 slidably moves. In an embodiment, the ratio of surface areas of the intensifier piston 116 to the intensifier plunger 118 is large so as to provide a large pressurizing effect. The body portion 106 may be coupled to the nozzle portion 108. The nozzle portion 108 may include the valve system 110. A person skilled in the art may appreciate that the solenoid portion 104, the body portion 106 and the nozzle portion 108 may be coupled together by welding, soldering, nut/bolt arrangement or other means known/feasible in the art, or may be made as an integrated unit.

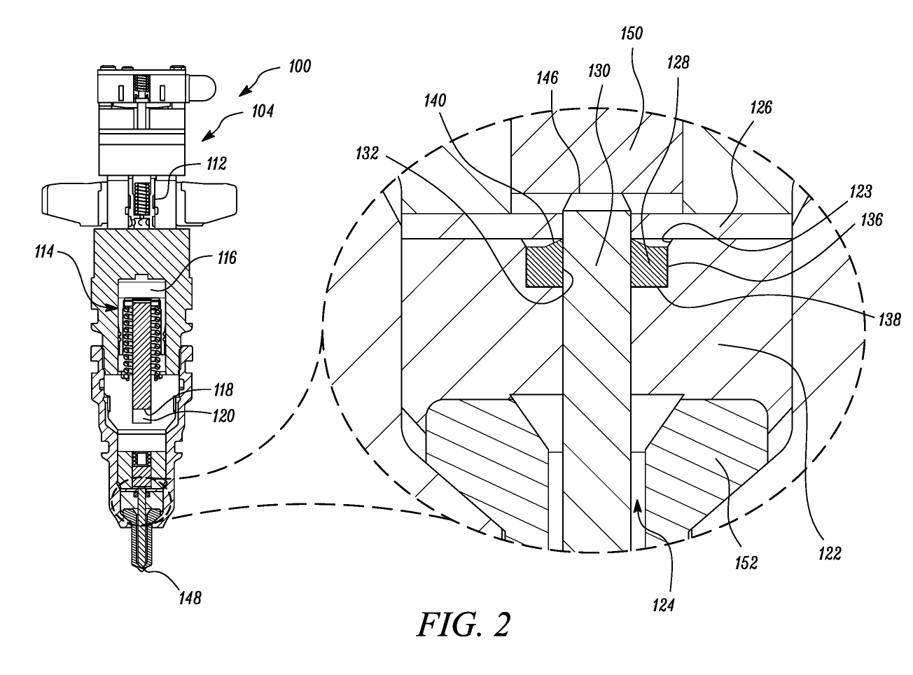

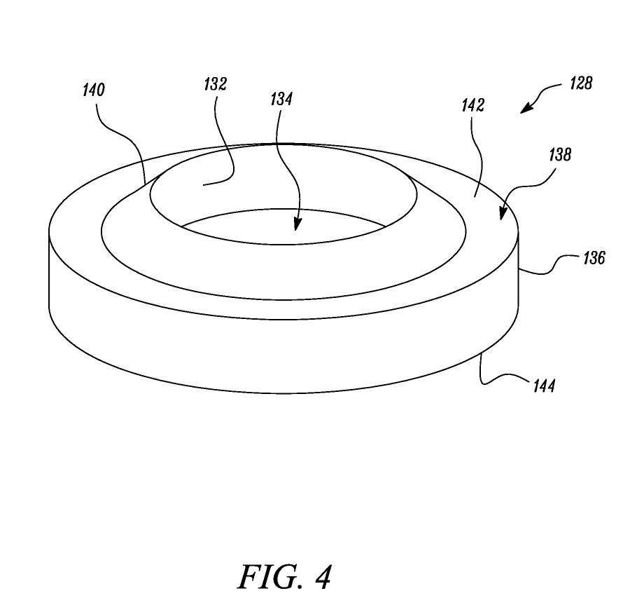

FIG. 2 illustrates an enlarged view of the valve system 110 of the fuel injector system 100. The valve system 110 may include a guide member 122 having a recess 123 and a passage 124, a plate member 126 placed above and abutting the guide member 122, a seal member 128 having a generally annular shape, and a valve stem 130. The seal member 128 is located in the recess 123, which acts as seat for the seal member 128. The seal member 128 (best shown in FIG. 4) may include an inner circumferential surface 132 defining a bore 134, an outer circumferential surface 136, an intermediate seal portion 138 and a ramp 140. The intermediate seal portion 138 extends radially between the inner circumferential surface 132 and the outer circumferential surface 136, and may include a first axial end surface 142 and a second axial end surface 144. The ramp 140 may be on at least one of the first axial end surface 142 and the second axial end surface 144. In the embodiment shown in FIG. 4 the ramp 140 is on the first axial end surface 142. The ramp 140 may descend from the inner circumferential surface 132 to one of the intermediate seal portion 138 or the outer circumferential surface 136. Accordingly, the inner circumferential surface 132 may have a larger axial length than the outer circumferential surface 136.

As shown in FIG. 2, the valve stem 130 is disposed within the passage 124 of the guide member 122 and the bore 134 of the seal member 128. The valve stem 130 may be configured to move axially relative to the guide member 122 and the seal member 128. The valve stem 130 may further include a first end 146 and a second end 148. The first end 146 may have a piston 150 attached to it. The piston 150 may be configured to be actuated by engine oil being provided by an oil pump (not shown). The second end 148 may be configured to alternately allow fluid to flow out of a nozzle tip 152 or block flow of fuel out of the nozzle tip 152 depending upon the actuation state of the solenoid valve 112. The nozzle tip 152 may be placed below and abutting the guide member 122. The passage 124 of the guide member 122 is further extended into the nozzle tip 152.

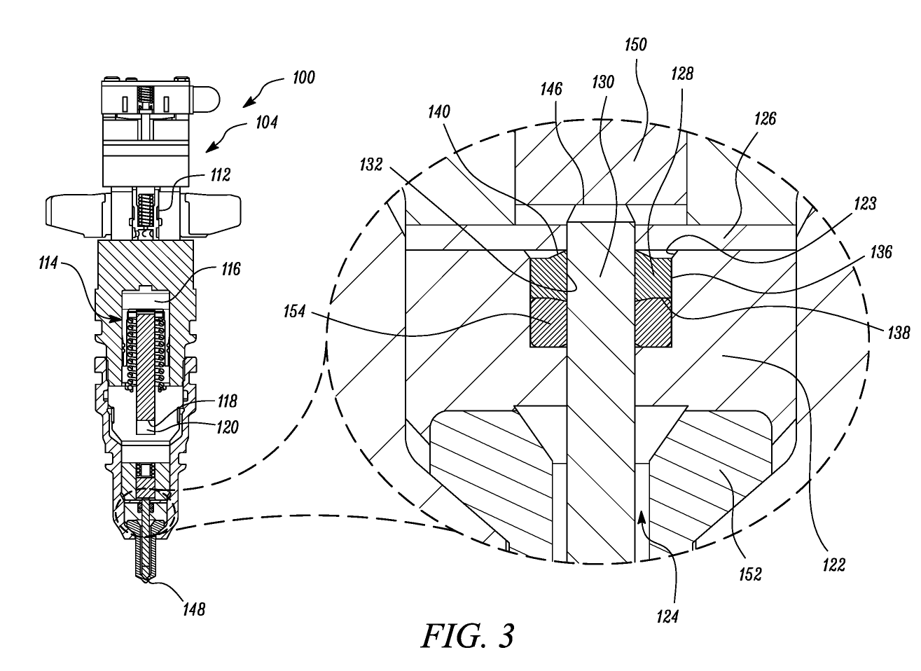

FIG. 3 illustrates an enlarged view of a valve system 110′ of the fuel injector system 100. The valve system 110′ may include the guide member 122 having the recess 123 and the passage 124, the seal member 128 having a generally annular shape, and the valve stem 130. The seal member 128 is located in the recess 123. The seal member 128 (best shown in FIG. 4) may include the inner circumferential surface 132 defining the bore 134, the outer circumferential surface 136, the intermediate seal portion 138 and the ramp 140. The intermediate seal portion 138 extends radially between the inner circumferential surface 132 and the outer circumferential surface 136, and may include the first axial end surface 142 and the second axial end surface 144. The ramp 140 may be on at least one of the first axial end surface 142 and the second axial end surface 144. In the embodiment shown in FIG. 3 the ramp 140 is on both the first axial end surface 142 and the second axial end surface 144. The valve system 110′ may further include a second seal member 154 placed below and abutting the second axial end surface 144 of the seal member 128. The second seal member 154 is also located in the recess 123 of the guide member 122. Although, in the present embodiment, the second seal member 154 is placed below and abutting the seal member 128, the second seal member 154 is not necessary for the seal member 128 to function. The embodiment just exemplifies a further possibility of retrofitting any existing seal together with the seal member 128.

FIG. 4 illustrates an exemplary isometric view of the seal member 128. In an embodiment, the seal member 128 may be of an annular shape. Although, the seal member 128 is shown in the drawings with ramp 140 descending from the inner circumferential surface 132 and ending on the intermediate seal portion 138, the ramp 140 may extend till the outer circumferential surface 136. Further, while the ramp 140 is generally shown as having a constant slope, it should be understood that the ramp 140 may have an irregular/variable slope or may be made in a step like pattern. Furthermore, it should be appreciated that the seal member 128 may have the ramp 140 on either the first axial end surface 142, the second axial end surface 144 or on both of them at the same time. The seal member 128 may be made of any suitable abrasion resistant material, including, for example, rubber, FKM, polyurethane or any other suitable material known in the art.

### INDUSTRIAL APPLICABILITY

The present disclosure discloses the fuel injector system 100 with the valve system 110. The disclosure provides restriction on mixing of fuel in a pressurized state and engine oil, the restriction being facilitated by the seal member 128 of the valve system 110. The disclosure provides for the seal member 128 having the bore 134 and positioned relative to the passage 124 of the guide member 122, and located in the recess 123. The disclosure further provides for the valve stem 130 disposed within the passage 124 of the guide member 122, and the bore 134 of the seal member. The seal member 128 having the ramp 140 descending from the inner circumferential surface 132 to one of the intermediate seal portion 138 or the outer circumferential surface 136, so that the mixing of pressurized fuel and engine oil may be avoided.

In an aspect of the present disclosure, the solenoid valve 112 is actuated and engine oil enters the intensifier assembly 114. The intensifier piston 116 is moved by engine oil thereby moving the intensifier plunger 118. The larger ratio of surface areas of the intensifier piston 116 and the intensifier plunger 118 helps in pressurizing the fuel present in the intensifier chamber 120. This pressurized fuel is allowed or blocked to flow inside a combustion chamber (not shown) by axial movement of the valve stem 130 and thereby of the second end 148, relative to the guide member 122 and the seal member 128. The axial movement of the valve stem 130 is carried out by the pressure of engine oil on the piston 150 attached to the first end 146 of the valve stem 130. The ramp 140 on one of the first axial end surface 142 and the second axial end surface 144 of the seal member 128 restricts the mixing of pressurized fuel and engine oil. The plate member 126 vitiates any unnecessary movement of the seal member 128 located in the recess 123.

In an aspect of the present disclosure, the seal member 128 for restricting intermixing of fuel and engine oil is disclosed. The ramp 140 of the seal member 128 is placed at the valve stem 130 to the passage 124 interface and thus reduces the likelihood of accumulation of debris/impurities. This in turn increases the longevity of the seal member 128 because of reduced corrosive impact of the debris/impurities.

The seal member 128 with the ramp 140 provided on both the first axial end surface 142 and the second axial end surface 144 provides for an option of retrofitting existing fuel injector systems with seals of different geometries. This is achieved because the ramp 140 on the first axial end surface 142 helps in non-accumulation of debris, while the ramp 140 on the second axial end surface 144 helps in plugging the deficiency of the existing or abraded geometries of presently used seals. For example, the second seal member 154 may be located in the recess 123, and placed below and abutting the seal member 128. This also obviates any need of replacing any existing seals with faulty geometry inside any injector system.

The seal member 128 with the ramp 140 eases the process of routine repair of the fuel injector system 100 with the valve system 110 without the need of replacing existing seals with faulty geometries. This also increases the operating time of any existing fuel injector systems.

What is claimed is:

1. A valve system comprising:
a guide member having a passage;
a generally annular seal member positioned relative to the passage, the seal member having an inner circumferential surface defining a bore, an outer circumferential surface, and an intermediate seal portion therebetween, the intermediate seal portion including a first axial end surface, and a second axial end surface,
wherein the seal member includes a ramp on at least one of the first axial end surface and the second axial end surface, the ramp descending from the inner circumferential surface to one of the intermediate seal portion or the outer circumferential surface; and
a valve stem disposed within the guide member passage and the bore of the seal member, the valve stem configured to move axially relative to the guide member and the seal member.

2. The valve system of claim 1, wherein the valve stem has a first end and a piston is attached to the first end.

3. The valve system of claim 2, wherein the piston is configured to be actuated by a pressure exerted by engine oil.

4. The valve system of claim 1, wherein the valve stem has a second end, and the second end is configured to control a flow of fuel from the valve system.

5. The valve system of claim 4, wherein fuel is in a pressurized state.

6. The valve system of claim 5, wherein an intensifier assembly is provided and is configured to pressure a fuel, the intensifier assembly being actuated by engine oil.

7. The valve system of claim 1, wherein the seal member is configured to restrict mixing of fuel in a pressurized state and engine oil.

8. The valve system of claim 1, further comprising a nozzle tip, wherein the passage is extended into the nozzle tip.

9. A fuel injector system comprising:
an injector body;
a valve system disposed within the injector body, the valve system comprising:
a guide member having a passage;
a generally annular seal member positioned relative to the passage, the seal member having an inner circumferential surface defining a bore, an outer circumferential surface, and an intermediate seal portion therebetween, the intermediate seal portion including a first axial end surface, and a second axial end surface,
wherein the seal member includes a ramp on at least one of the first axial end surface and the second axial end surface, the ramp descending from the inner circumferential surface to one of the intermediate seal portion or the outer circumferential surface; and
a valve stem disposed within the guide member passage and the bore of the seal member, the valve stem configured to move axially relative to the guide member and the seal member.

10. The fuel injector system of claim 9, wherein the valve stem has a first end and a piston is attached to the first end.

11. The fuel injector system of claim 10, wherein the piston is configured to be actuated by a pressure exerted by engine oil.

12. The fuel injector system of claim 9, wherein the valve stem has a second end, and the second end is configured to control a flow of fuel from the valve system.

13. The fuel injector system of claim 12, wherein fuel is in a pressurized state.

14. The fuel injector system of claim 13, wherein an intensifier assembly is provided and is configured to pressure a fuel, the intensifier assembly being actuated by engine oil.

15. The fuel injector system of claim 9, wherein the seal member is configured to restrict mixing of fuel in a pressurized state and engine oil.

16. The fuel injector system of claim 9, wherein the fuel injector system is a unit injector system.

17. The fuel injector system of claim 16, wherein the unit injector system is a hydraulically-actuated electronically-controlled unit injector system.

18. The fuel injector system of claim 9, further comprising a nozzle tip, wherein the passage is extended into the nozzle tip.

19. A seal member having a generally annular shape comprising:
an inner circumferential surface defining a bore;
an outer circumferential surface;
an intermediate seal portion therebetween, the intermediate seal portion including a first axial end surface, and a second axial end surface; and
a ramp on at least one of the first axial end surface and the second axial end surface, the ramp descending from the inner circumferential surface to one of the intermediate seal portion or the outer circumferential surface.

20. A fuel injector including a seal as recited in claim 19.
